(19) United States
(12) Patent Application Publication
(10) Pub. No.: US 2025/0224697 A1
(43) Pub. Date: Jul. 10, 2025

(54) TIMEPIECE DRIVE DEVICE

(71) Applicant: ROLEX SA, Geneva (CH)

(72) Inventors: Sacha Maffioli, Veigy-Foncenex (FR); Daniel Moille, Douvaine (FR)

(73) Assignee: ROLEX SA, Geneva (CH)

(21) Appl. No.: 18/983,698

(22) Filed: Dec. 17, 2024

(30) Foreign Application Priority Data
Dec. 22, 2023 (EP) 23219714.5

(51) Int. Cl. G04B 19/253

(52) U.S. Cl. CPC G04B 19/25393

(57) ABSTRACT

The timepiece drive device (100), notably for a system (300) for displaying time-based or time-derived information, in particular for an instantaneous-jump calendar system, includes an input mobile (10) which includes a first toothing (10a), a main wheel (11) which includes a second toothing (11a) only over part of the periphery of the main wheel, the second toothing being in meshing engagement with the first toothing, a cam (12) which is connected to the main wheel (11), notably connected to the main wheel (11) with minimum clearance, in particular fixed to the main wheel (11), and which has a cam profile (12a, 12b, 12c), a cam follower (21) which interacts with the profile (12a, 12b, 12c), and an energy accumulator (22) which elastically returns the cam follower against the profile (12a, 12b, 12c) of the cam (12).

### CROSS-REFERENCE TO RELATED APPLICATION

This application claims priority of European patent application No. EP23219714.5 filed Dec. 22, 2023, the content of which is hereby incorporated by reference herein in its entirety.

### FIELD OF THE INVENTION

The invention relates to a timepiece drive device. The invention also relates to a timepiece calendar comprising such a timepiece drive device. The invention further relates to a timepiece movement comprising such a timepiece drive device or such a timepiece calendar. The invention also relates to a timepiece comprising such a timepiece movement or such a timepiece drive device or such a timepiece calendar. The invention also relates to a method for operating such a timepiece movement or such a timepiece or such a timepiece drive device or such a timepiece calendar.

### BACKGROUND ART

The prior art discloses instantaneous timepiece calendar systems which have a drive mobile provided with a cam that interacts with an energy accumulation device, such as a cam lever associated with a spring.

Driven by a drive wheel, the cam makes it possible to arm the energy accumulation device in an arming phase and, successively, return the energy during a phase of instantaneous driving of the calendar. The cam is then driven and turns relative to the drive wheel. The energy returned serves to drive the cam and a mechanism arranged downstream of the cam.

After the instantaneous driving phase, in a compensation phase, the cam is immobilized until it is caught up with and driven again by the drive wheel so as to arm the energy accumulation device.

The compensation phase can last approximately 4 to 11 hours depending on the design of the calendar. During this compensation phase, the drive wheel turns with no load and consumes very little energy compared to the arming phase. This results in variations in the amplitude of the oscillator of the timepiece movement (assuming a mechanical timepiece movement) owing to the difference in load exerted on the drive wheel between the phases respectively of compensation and arming.

Patent application CH256366A4 discloses a drive mobile for driving a date disk. The drive mobile comprises a first wheel and a second wheel which are coaxial and able to be driven at different angular speeds, by respectively two integral pinions. The angular speed of the first wheel is slightly less than that of the second wheel. The two wheels are interconnected by a spring 14 intended to be wound incrementally with the angular offset brought about by the difference in speed between said wheels. The toothing of the first wheel is truncated on one portion. When this portion is facing its drive pinion, the first wheel is free to abruptly drive the date disk, under the effect of the spring disarming. After the driving, the spring is gradually rewound as soon as the toothing of the first wheel is reengaged with that of its drive pinion. The solution proposed here does not make it possible to optimize the energy consumption of the movement driving such a date mechanism.

### SUMMARY OF THE INVENTION

The object of the invention is to provide a timepiece drive device that improves the devices known from the prior art. In particular, the invention provides a timepiece drive device for optimally spreading the energy consumption out over time, in particular over a period of rotation of a drive wheel.

According to the invention, a drive device is defined by point 1 below.

1. A timepiece drive device, notably for a system for displaying time-based or time-derived information, in particular for an instantaneous-jump calendar system, comprising:
an input mobile which comprises a first toothing;
a main wheel which includes a second toothing only over part of the periphery of the main wheel, the second toothing being in meshing engagement with the first toothing,
a cam which is connected to the main wheel, notably connected to the main wheel with minimum clearance, in particular fixed to the main wheel, and has a cam profile,
a cam follower which interacts with the profile, and
an energy accumulator which elastically returns the cam follower against the profile of the cam.

Embodiments of the drive device are defined by points 2 to 8 below.

2. The timepiece drive device as defined in point 1, wherein the angular extent of the periphery of the main wheel which comprises the second toothing is equal or substantially equal to the angular travel covered by the cam when it is not driven by the energy accumulator via the cam follower and/or the angular extent of the periphery of the main wheel without a toothing is equal or substantially equal to the angular travel covered by the cam when it is driven by the energy accumulator via the cam follower, and/or
wherein the timepiece drive device, notably the cam, the first toothing and the second toothing, is arranged such that an action of the cam follower on the cam causes the main wheel to rotate independently of the input mobile.

3. The timepiece drive device as defined in point 1 or 2, wherein the timepiece drive device, notably the cam, the first toothing and the second toothing, is arranged so as to arm the energy accumulator via the cam follower substantially permanently, except for driving phases in which the cam is driven by the energy accumulator via the cam follower.

4. The timepiece drive device as defined in one of the preceding points, wherein the drive device is arranged such that:
the cam is driving by an action of the energy accumulator via the cam follower over a first angular extent, and
the cam supplies energy to the energy accumulator via the cam follower over a second angular extent which complements the first angular extent.

5. The timepiece drive device as defined in one of the preceding points, wherein the drive device, in particular the profile of the cam, is arranged such that the mechanical power supplied to the energy accumulator is constant or substantially constant throughout the period of time or substantially throughout the period of time during which the cam is not driven by the energy accumulator via the cam follower.

6. The timepiece drive device as defined in one of the preceding points, wherein the cam follower comprises a lever.

7. The timepiece drive device as defined in one of the preceding points, wherein the energy accumulator comprises a spring, notably a spring blade.

8. The timepiece drive device as defined in one of the preceding points, wherein the cam is kinematically connected to a drive element for driving a display element for displaying time-based information, notably is fixed to a drive element for driving a display element for displaying time-based information, such as a finger, interacting with a toothing of a display element for displaying time-based information.

According to the invention, a timepiece calendar is defined by point 9 below.

9. A timepiece calendar, notably a simple date calendar or an annual calendar or a perpetual calendar, comprising a timepiece drive device as defined in one of the preceding points, the calendar comprising a display element for displaying time-based information, such as a disk bearing numerals, including a toothing.

According to the invention, a timepiece movement is defined by point 10 below.

10. A timepiece movement comprising:
a timepiece drive device as defined in one of points 1 to 8, and/or
a timepiece calendar as defined in the preceding point.

According to the invention, a timepiece is defined by point 11 below.

11. A timepiece, notably a wristwatch, comprising:
a timepiece movement as defined in point 10, and/or
a timepiece calendar as defined in point 9, and/or
a timepiece drive device as defined in one of points 1 to 8.

According to the invention, an operating method is defined by point 12 below.

12. A method for operating a timepiece drive device, the timepiece drive device comprising:
a cam,
a cam follower, and
an energy accumulator which returns the cam follower against the cam,
the method comprising arming the energy accumulator via the cam follower substantially permanently, except for driving phases in which the cam is driven by the energy accumulator via the cam follower.

Embodiments of the operating method are defined by points 13 to 15 below.

13. The operating method as defined in the preceding point, wherein the duration of the arming corresponds to at least 90% of the time of the period of rotation of the main wheel of the timepiece drive device, or even at least 99%, or even at least 99.5%, or even substantially 100% of the time of the period of rotation of the main wheel of the timepiece drive device.

14. The operating method as defined in point 12 or 13, notably method for operating a timepiece as defined in point 11 or a timepiece movement as defined in point 10 or a timepiece calendar as defined in point 9 or a timepiece drive device as defined in one of points 1 to 8, the method comprising at least one iteration of the following steps:
bringing a first toothing and a second toothing into meshing engagement so as to drive the cam for arming the energy accumulator, and then
bringing the first toothing and the second toothing out of meshing engagement and driving the cam by the energy accumulator via the cam follower.

15. The operating method as defined in one of points 12 to 14, wherein the drive of the cam is an instantaneous drive.

### BRIEF DESCRIPTION OF THE DRAWINGS

The appended drawings depict, by way of example, two embodiments of a timepiece according to the invention.

FIG. 1 is a view of a first embodiment of a timepiece according to the invention, with a drive device being shown from the dial side.

FIG. 2 is a view of the first embodiment of the timepiece according to the invention, with the drive device being shown from the movement side.

FIG. 3 is a set of views of elements forming part of the first embodiment of the drive device, comprising an exploded view and two perspective views.

FIGS. 4 to 8 are views of operating sequences of the drive device of the first embodiment.

FIG. 9 is a set of views of the second embodiment of the drive device, comprising an exploded view and two perspective views.

FIGS. 10 to 16 are views of operating sequences of the drive device of the second embodiment.

### DETAILED DESCRIPTION OF PARTICULAR EMBODIMENTS

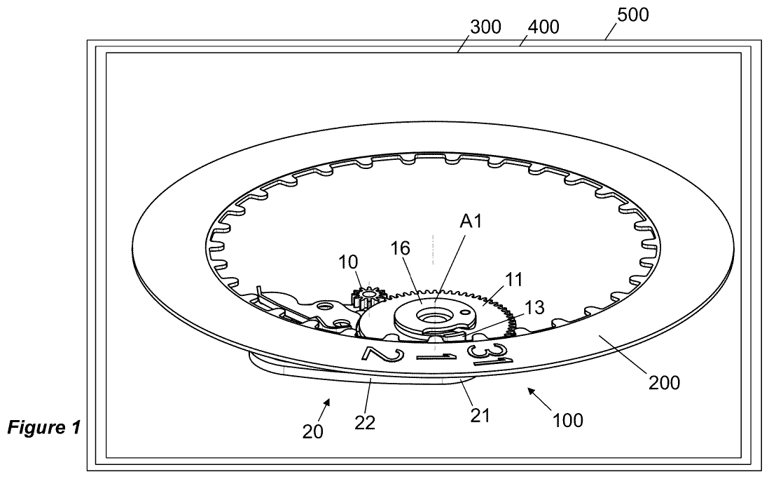

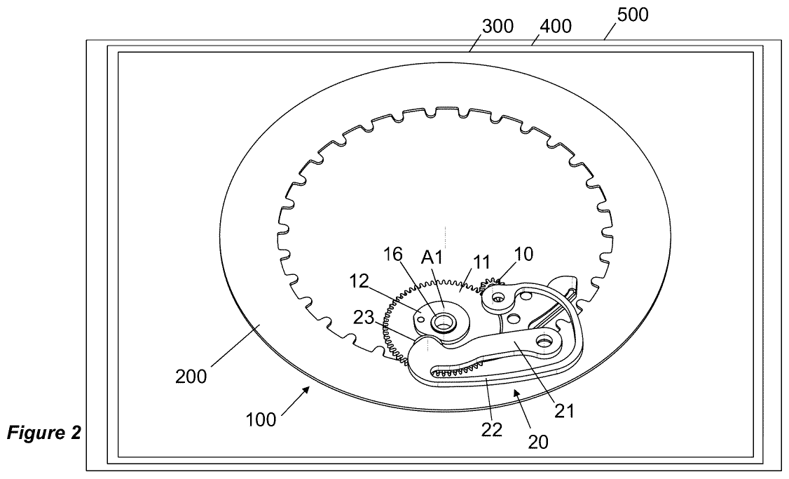

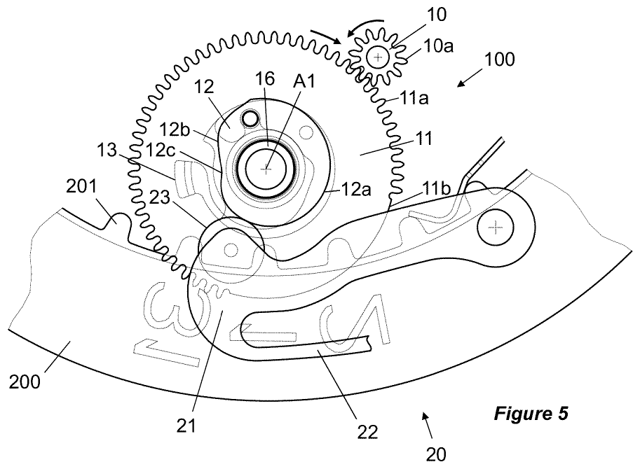

A first embodiment of a timepiece 500 is described below in detail with reference to FIGS. 1 to 8.

The timepiece 500 is for example a watch, in particular a wristwatch. The timepiece 500 comprises a timepiece movement 400 intended to be mounted in a timepiece casing or case in order to protect it from the external environment.

The timepiece movement 400 is a mechanical movement, notably an automatic movement, or a hybrid movement, or an electronic movement.

The timepiece movement 400 comprises a system 300 for displaying time-based or time-derived information, such as a timepiece calendar 300, in particular an instantaneous-jump calendar.

The system 300 for displaying time-based or time-derived information comprises:
at least one display member 200, notably a member for displaying the days of the month, in particular a disk for displaying the days of the month, and
a timepiece drive device 100,
the at least one display member 200 and the drive device 100 being arranged such that the drive device 100 is capable of driving the at least one display member 200. The drive is of the instantaneous or instantaneous jump type.

The system 300 for displaying time-based or time-derived information makes it possible for example to display, via the at least one display member 200, at least one item of calendar information such as information about the day, day of the month, month, year, leap year, moon phase.

The at least one item of calendar information may be indicated or borne by the at least one display member 200, which may for example take the form of a hand or a disk.

The timepiece drive device 100 comprises:
an input mobile 10 which comprises a first toothing 10a;
a main wheel 11 which includes a second toothing 11a only over part of the periphery of the main wheel, the second toothing being in meshing engagement with the first toothing,
a cam 12 which is connected to the main wheel 11, notably connected to the main wheel 11 with minimum clearance, in particular fixed to the main wheel 11, and has a cam profile 12a, 12b, 12c,
a cam follower 21 which interacts with the profile 12a, 12b, 12c, and
an energy accumulator 22 which elastically returns the cam follower against the profile 12a, 12b, 12c of the cam 12.

A “connection with minimum clearance” is understood to mean:
a connection without a clearance, for example a fixing, or
a connection with a very small assembly clearance, or
a meshing connection exhibiting a meshing clearance.

The timepiece drive device 100, notably the cam, the first toothing and the second toothing, may be arranged such that rotations of the main wheel 11 independently of the input mobile 10 are allowed during time ranges and are caused by the action of the cam follower 21 on the cam 12. Thus, an action of the cam follower 21 on the cam 12 can cause the main wheel 11 to rotate independently of the input mobile 10.

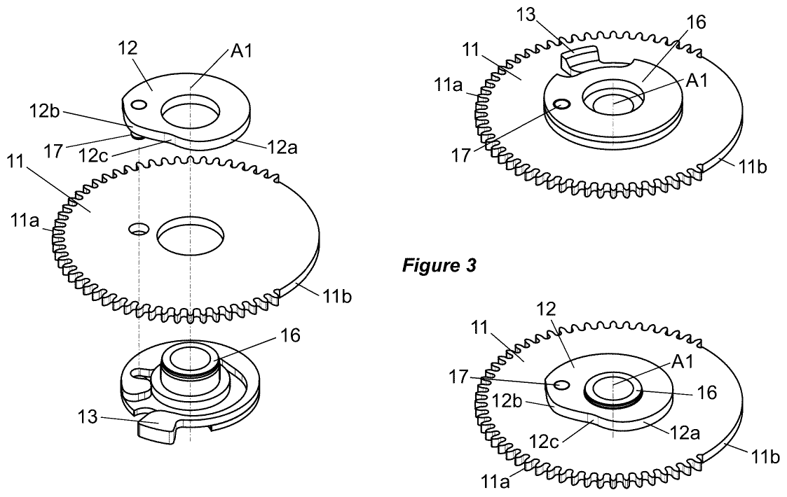

As depicted in particular in FIG. 3, the instantaneous drive device 100 comprises a main mobile comprising the main drive wheel 11, but also:
a drive element 13, and
the cam 12.

The main wheel 11, the cam 12 and the drive element 13 are secured to one another. In particular, the main wheel 11, the cam 12 and the drive element 13 are fixed to one another.

The main mobile is pivoted within a frame of the timepiece movement 400 or a frame of a calendar module about an axis A1. The drive element 13 is intended to directly and periodically drive the display member 200, for example by interacting with teeth of a toothing of the display member 200 by obstructing them.

The instantaneous drive device 100 also comprises an energy accumulation device 20 with which the cam 12 is intended to interact so as to periodically accumulate and periodically return the energy required for instantaneous driving of the display member 200.

The energy accumulation device 20 comprises:
a cam follower 21, such as a cam lever 21 pivoted within the frame, and
an energy accumulator 22 such as a spring or an elastic return means 22 which makes it possible to accumulate the energy required for instantaneous driving of the display member 200. In addition, the elastic return means 22 tends to return the lever 21 against the cam 12. Thus, with preference, the lever 21 can be constantly in contact with the cam 12.

The energy accumulation device 20 may be in one piece.

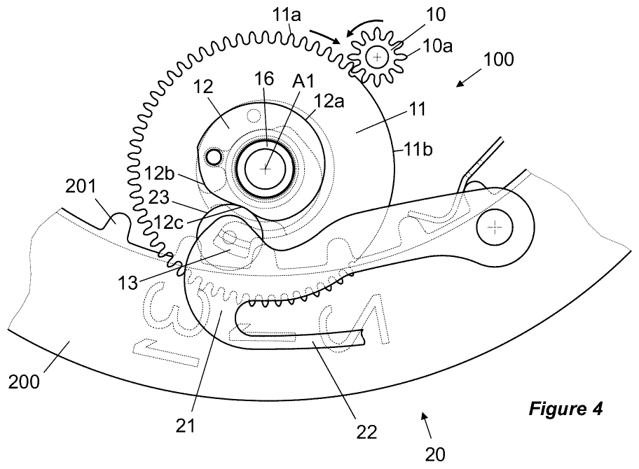

As illustrated in FIG. 4, the main drive wheel 11 is intended to be driven by a mobile 10 kinematically connected to a train of the timepiece movement 400. The mobile 10 may be part of the instantaneous drive system 100. More particularly, the main wheel 11 comprises a toothing 11a capable of interacting with a toothing 10a of the mobile 10. With preference, the mobile 10 turns at a constant speed while the timepiece movement 400 is operating.

A particular feature of the solution is that the toothing 11a is interrupted or truncated over a portion 11b of the main drive wheel 11. Notably, the toothing 11a is produced around the periphery of the main wheel 11. This periphery thus has a part which is smooth or without a toothing. This smooth part has for example a radius substantially equal to the radius of the pitch circle (as explained below). As a result, the shaping of the portion 11b means that the main wheel 11 is not driven by the mobile 10 over a given angular extent. In other words, the portion 11b makes it possible to decouple the main wheel 11 from, or take it out of meshing engagement with, the mobile 10, in particular the toothing 10a.

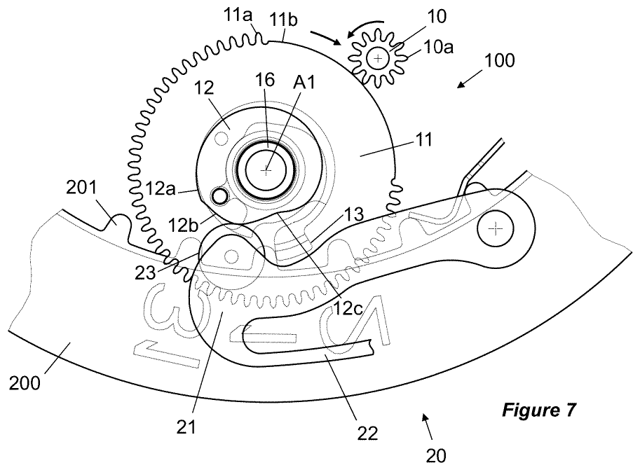

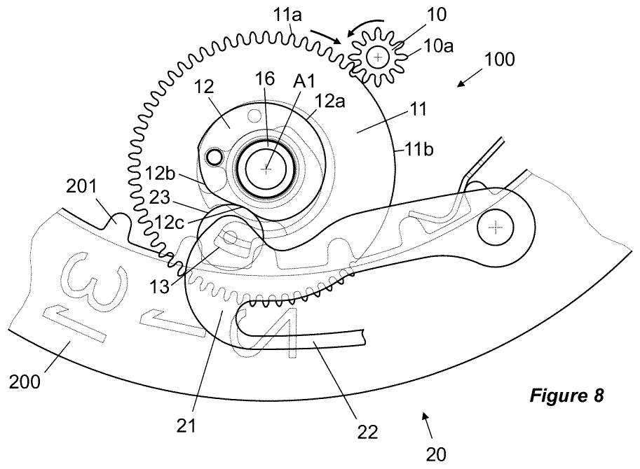

Thus, as depicted in FIGS. 4, 5 and 6, the toothing 11a is driven by the mobile 10 during an arming phase, thus making it possible to arm the energy accumulation device 20. Furthermore, as depicted in FIGS. 7 and 8, in an instantaneous driving phase, the portion 11b makes it possible to instantaneously return the energy accumulated within the energy accumulation device 20 during the preceding arming phase owing to the decoupling of the main wheel 11 and the mobile 10. The instantaneous driving phase thus corresponds to the phase in which the display member 200 is driven instantaneously by the drive element 13. During this phase, when the main wheel 11 is decoupled from or taken out of meshing engagement with the mobile 10, the main wheel 11 turns and instantaneously or virtually instantaneously travels the angular extent of the portion 11b until the toothing 11a is reengaged with the toothing 10a of the mobile 10a. The angular extent of the portion 11b (about the axis A1) is consequently equal or substantially equal to the angular travel (about the axis A1) covered by the cam 12 during the instantaneous driving phase.

On the transition between respectively the instantaneous-jump phase and the arming phase, it is possible to initiate the driving of the main wheel 11 with a small latency or a small delay owing to the meshing clearance between the toothings 11a and 10a. In other words, during the arming phase, the effective arming of the energy accumulation device 20 can be initiated with a delay or lag resulting from the meshing clearance and its compensation by rotation of the mobile 10. This lag may be about several minutes. With preference, the profiles of the toothings are selected so as to limit, or even eliminate the clearances as far as possible. Thus, with preference, the lag is less than 5 minutes, or even less than 3 minutes or else less than 1 minute. A toothing without clearance or any other clearance compensation device could be utilized to limit or eliminate the clearance of this meshing engagement. Consequently, the timepiece drive device 100, notably the cam 12, the first toothing 10a and the second toothing 11a, is arranged so as to arm the energy accumulator 22 via the cam follower 21 substantially permanently, except for driving phases in which the cam 12 is driven by the energy accumulator 22 via the cam follower 21. For example:
ignoring the meshing clearances and considering a jump of 1/25^{e} of a second, the arming duration corresponds to 99.99% of the period of rotation of the main wheel 11,
considering a lag of 1 minute owing to the meshing clearances, the arming duration corresponds to 99.9% of the period of rotation of the main wheel 11,
considering a lag of 3 minutes owing to the meshing clearances, the arming duration corresponds to 99.8% of the period of rotation of the main wheel 11, and
considering a lag of 5 minutes owing to the meshing clearances, the arming duration corresponds to 99.7% of the period of rotation of the main wheel 11.

More generally, from one phase to the next, the meshing transitions between the toothing 10a and the toothing 11a are dimensioned so as to be as continuous as possible, without abrupt interruption or without significantly adversely affecting the energy consumption of the timepiece movement 400, and thus avoid variations in amplitude of the oscillator (assuming a mechanical timepiece movement). Of course, the geometries of the toothings 10a and 11a are selected so as to make it possible to take them out of meshing engagement and place them in meshing engagement in succession, from one phase to the next. To this end, the profile of the toothing 11a may notably be corrected or adapted at the start and/or end of the driving.

It is provided that the arming phase and the instantaneous driving phase follow one another indefinitely, such that the arming phase is effective substantially throughout the period of rotation of the main wheel 11, except for the instantaneous driving phase and the potential lag caused by the meshing clearances on the transition between the instantaneous-jump phase and the arming phase. In other words, the instantaneous drive device 100 is provided so as to make it possible to arm the energy accumulation device 20 substantially permanently, substantially throughout the period of rotation of the main drive wheel 11, as the instantaneous driving and clearance compensation phases are extremely brief.

In a first embodiment, the instantaneous drive device 100 is provided to make it possible to instantaneously drive a date calendar system 300 comprising a date disk 200 indexed by a jumper.

The drive element 13 may be a date finger 13 intended to interact with a toothing 201 of the date disk 200 during the instantaneous driving phase. The date finger 13 is in this case fixed, notably welded, to a core 16 which itself is driven into and/or riveted onto the cam 12. The main drive wheel 11 is also driven into and/or riveted onto the core 16.

The core 16 is pivoted on the frame about the axis A1. With preference, at least one indexing means 17 such as a pin 17 is arranged within the main wheel so as to angularly index the main wheel 11 with the cam 12 and the date finger 13.

The profile of the cam 12 which interacts with the energy accumulation device 20 comprises, in succession, an arming portion 12a, a return portion 12b and a stop portion 12c. The functionalities of these portions are described in more detail below.

The period of rotation of the main drive wheel 11 is 24 hours, so as to make it possible to drive the calendar system 300 by at least one pitch per day. In other words, for each period of rotation of the main wheel 11, the instantaneous drive device 100 will be exclusively and successively in the arming phase or the instantaneous driving phase (outside of possible compensations of the toothing clearances).

The angular extent of the portion 11b corresponds to the angular travel covered instantaneously by the cam 12 relative to the axis A1, in the instantaneous driving phase. In other words, it corresponds to the angular travel covered by the cam 12 during the successive interaction of the cam lever 21 with the return portion 12b and with the stop portion 12c. In addition, the angular extent of the periphery of the main wheel 11 without a toothing is equal or substantially equal to the angular travel covered by the cam 12 when it is driven by the energy accumulator 22 via the cam follower 21.

The angular extent of the periphery of the main wheel comprising the second toothing 11a is substantially equal or equal to the angular travel covered draggingly by the cam 12 in the arming phase, when the cam lever 21 interacts with the arming portion 12a.

The transmission ratio between the main wheel 11 and the mobile 10 is selected such that the toothing 10a drives all of the toothing 11a over a duration or a period corresponding substantially to the period of rotation of the main wheel 11. In other words, the period of rotation of the main wheel 11 comprises a dragging rotation defined by the angular extent of the toothing 11a and an instantaneous rotation defined by the angular extent of the portion 11b. Consequently, the angular speed of the main wheel 11 is not constant throughout its period of rotation.

The cam lever 21 interacts with the cam 12 via a bearing, more particularly a stone or a runner 23 made of ruby. The runner 23 makes it possible to reduce the friction torque induced by the bearing force exerted on the cam 12 by the lever 21. Consequently, this runner 23 makes it possible to reduce the energy consumption and the losses of amplitude of the oscillator of the timepiece movement 400 (assuming a mechanical timepiece movement).

The drive device is thus arranged such that:
the cam 12 is driving by an action of the energy accumulator 22 via the cam follower 21 over a first angular extent, corresponding to the cam profile portions 12b, 12c, and
the cam 12 supplies energy to the energy accumulator 22 via the cam follower over a second angular extent, corresponding to the cam profile portion 12a, which complements the first angular extent.

### Arming Phase

During the arming phase, as illustrated by the succession of FIGS. 4 to 6, the lever 21, in particular the runner 23, comes out of the stop portion 12c and bears against the arming portion 12a. This portion 12a is shaped so as to arm the energy accumulation device 20 and thus accumulate the energy required to instantaneously drive the display member 200 by at least one pitch. During the arming phase, the cam 12 is driven by the main drive wheel 11 in the sense of the hands of a watch through the effect of the interaction of the toothing 10a of the mobile 10 with the toothing 11a.

With preference, the arming portion 12a is shaped so as to minimize and make constant a consumption and loss of amplitude of the oscillator (in the case of a mechanical timepiece movement). In other words, the arming portion 12a makes it possible to obtain a constant and minimized arming torque at the main drive wheel 11.

### Driving Phase

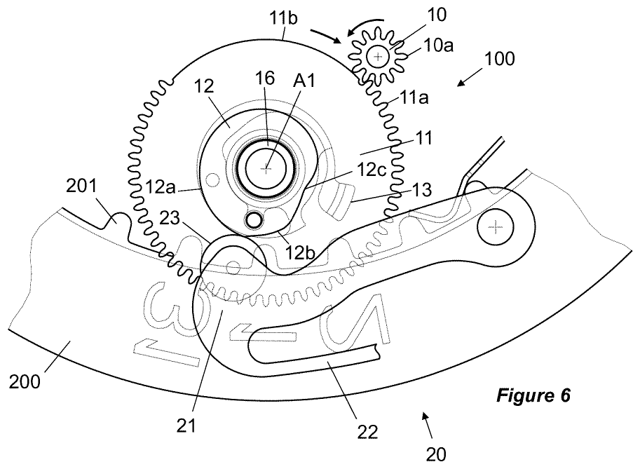

As illustrated in FIG. 6, when the lever 21, in particular the runner 23, arrives at the peak of the cam 12, at the end of the arming portion 12a, at the exact moment it transitions to the return portion 12b, the lever 21, in particular the runner 23, instantaneously travels over the return portion 12b until it reaches the stop portion 12c. This transition also substantially corresponds to the moment when the toothing 10a is taken out of engagement with the toothing 11a and faces the portion 11b. The main wheel 11 is then decoupled from the mobile 10. Therefore, the main wheel 11 can freely and instantly travel, in the sense of the hands of a watch, all of the angular extent of the portion 11b necessary for the driving phase.

Ideally, the decoupling and the transition from the peak of the cam should happen simultaneously. In practice, this is not possible. The decoupling cannot happen just before the transition from the peak, as otherwise there is the risk that the mobile 10 can no longer drive the main wheel 11. The decoupling must therefore happen just after the peak of the cam has been passed, or the start of the jump. On account of the fact that at the moment the peak of the cam is passed, only the last tooth of the toothing 11a is still engaged with the toothing 10a and when the driving ends, this tooth can freely come out of the toothing 10a just after the peak of the cam has been passed.

During the driving phase, as illustrated in FIG. 7, the energy stored by the energy accumulation device 20 is returned to allow the rotation of the main mobile and consequently the instantaneous drive of the display member 200 by the date finger 13. In other words, at midnight, the cam 12 and the date finger 13 both become drivers by virtue of the return of the accumulated energy.

At the end of the driving phase, it is necessary that the date finger 13 is stopped and remains positioned in a position of interference with the toothing 201 of the date disk 200 in order to obstruct it and thus avoid an inadvertent additional jump on account of its inertia and the considerable energy released during this phase.

To this end, as illustrated in FIG. 8, the lever 21, in particular the runner 23, is on the stop portion 12c which is dimensioned so as to dissipate the residual kinematic energy after the display member 200 has been driven.

The stopping of the display member 200 is also instantaneous. In other words, the instantaneous driving phase includes the stopping of the display member 200.

Therefore, the toothing 10a of the pinion 10 is within range of the toothing 11a again so as to allow a new meshing engagement and in such a way that a new arming phase is initiated.

With preference, at least a first tooth of the toothing 11a is optimized so as to limit the meshing clearance with the toothing 10a, and reduce the transition time between respectively the instantaneous-jump phase and the arming phase.

In addition or as an alternative, at least a first tooth of the toothing 11a can in this phase be utilized to make it possible to partially or completely dissipate said residual kinematic energy. Said tooth can consequently have an optimized geometry for better supporting the dissipation of energy. In relation to the rest of the toothing 11a, the first tooth can notably have a greater thickness and/or an asymmetrical profile for better distributing the stresses, and therefore limiting the concentrations of stresses over said tooth so as to exhibit better strength.

### Resetting of the Time in the Opposite Direction

Advantageously, in order to avoid desynchronization between the main wheel 11 and the train of the timepiece movement 400 during notably a resetting of the time in the opposite direction of operation, the conformation of the portion 11b with the toothing 10a is provided so as to prevent the rotation of the latter, like a Maltese cross. Specifically, the portion 11b has a cylindrical portion which is concentric with the axis A1 and has a diameter close to the pitch diameter of the toothing 11a so as to be capable of interacting with the adjacent flanks of two teeth of the toothing 10a and prevent it from rotating.

As an alternative or in addition, the rotation of the mobile 10 in the opposite direction of operation and the drive of the display member 200 in the opposite direction can be prevented by a freewheel or a unidirectional coupling arranged between said mobile and the train of the timepiece movement 400. Of course, the unidirectional coupling must be shaped so as to preserve the synchronization of the triggering of the instantaneous driving phases with the train of the timepiece movement 400.

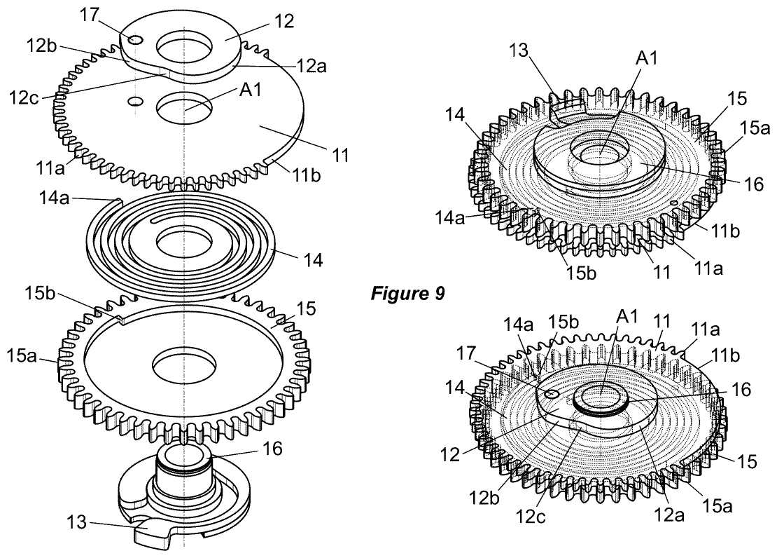

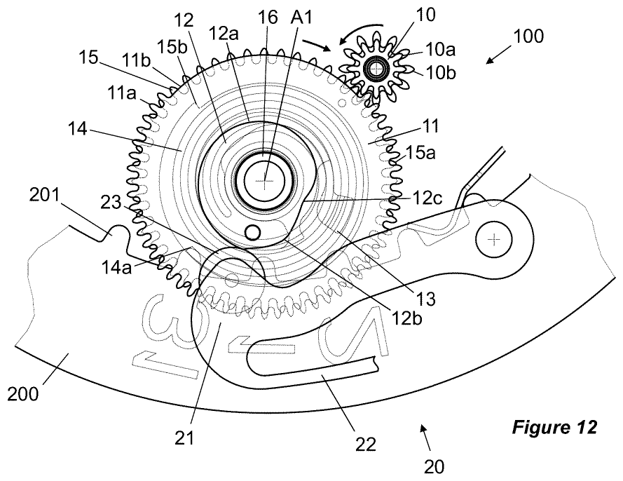

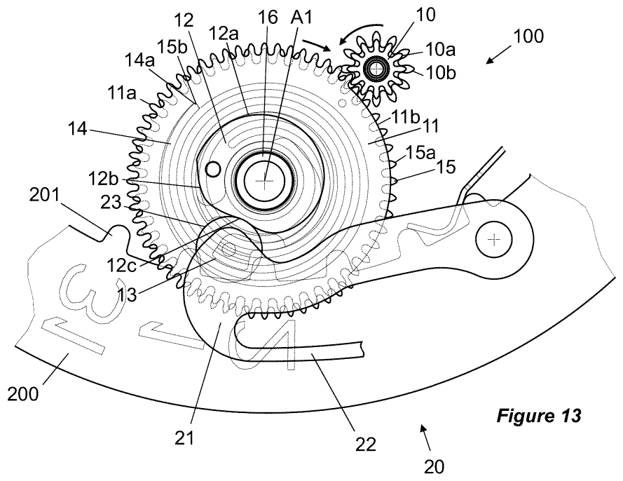

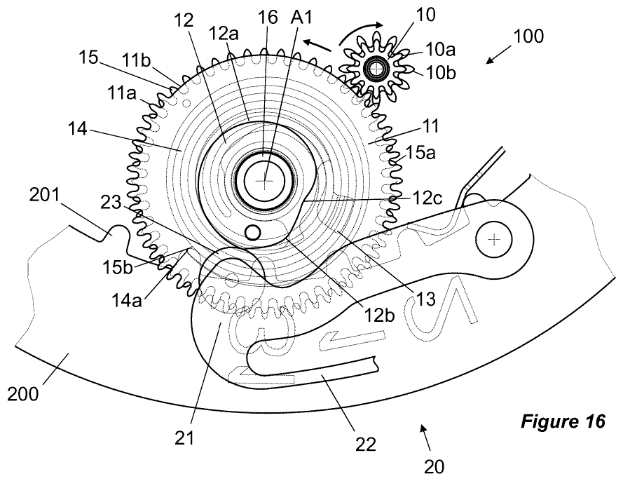

A second embodiment of a timepiece 400 is described below in detail with reference to FIGS. 9 to 16.

This second embodiment advantageously comprises the same means or substantially the means as those of the first embodiment, except that it is notably additionally provided with an auxiliary mobile preventing the desynchronization of the main wheel 11 relative to the train of the timepiece movement 400. The auxiliary mobile also makes it possible to drive the display member 200 during a resetting of the time in the opposite direction of operation.

The auxiliary mobile is also pivoted within the frame. The auxiliary mobile comprises an auxiliary drive wheel 15 which is constantly driven by the train of the timepiece movement 400. The auxiliary drive wheel 15 is capable of interacting with an elastic device 14 fixed to the main mobile or secured to the main mobile.

More particularly, in this embodiment, the auxiliary mobile is coaxial with the main mobile. The auxiliary drive wheel 15 pivots about the core 16. The elastic device 14 is a helical spring 14, the inner end of which is driven into or riveted onto the core 16 secured to the main wheel 11 and to the cam 12. The outer end 14a of the spring 14 is capable of interacting with an angular stop 15b arranged on the auxiliary drive wheel 15.

The utilization of the interaction of the auxiliary drive wheel 15 with the spring 14 is explained in detail below.

In this second embodiment, the mobile 10 comprises an auxiliary toothing 10b which meshes constantly with a toothing 15a of the auxiliary drive wheel 15 such that its rotational speed is constant and entirely synchronized with the train of the timepiece movement 400.

The transmission ratio between the pinion 10 and the auxiliary drive wheel 15 is selected such that the latter has the same period of rotation as the main drive wheel 11. It should be noted that the auxiliary drive wheel 15 performs a dragging rotation, at a constant speed, throughout its period of rotation, by contrast to the main drive wheel 11 which performs a dragging rotation over an angular extent defined by the toothing 11a, and an instantaneous rotation over an angular extent defined by the portion 11b. As a result, the duration or the period in which the toothing 10a is engaged with the toothing 11a is identical or substantially identical to the period of rotation of the auxiliary drive wheel 15.

Consequently, in the arming phase, the angular speed of the auxiliary wheel 15 is higher than that of the main wheel 11. As explained in more detail below, relative to the auxiliary wheel 15, the main wheel 11 compensates for its angular offset, accumulated gradually during the arming phase, during the instantaneous driving phase.

The mode of operation of the second embodiment is substantially the same as that of the first embodiment. Only the interaction of the spring 14 with the auxiliary drive wheel 15 adds new functionalities, which are explained below.

In a variant, in this second embodiment, the main mobile and the auxiliary mobile of the drive device could be not coaxial, but pivoted on two separate, preferably parallel axes. They would then be connected for example by a meshing engagement.

In a further variant, in this second embodiment, the elastic device 14 could comprise a lever or a click interacting with the spring element.

### Arming Phase

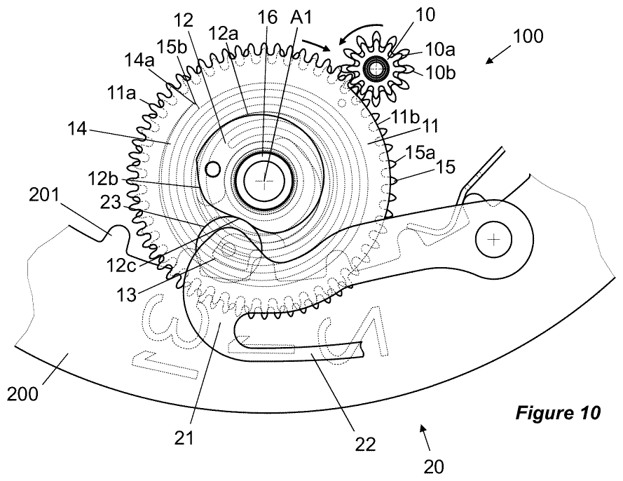

In the second embodiment, at the start of the arming phase, immediately after the end of the driving phase illustrated in FIG. 10, the free end 14a of the spring 14 is substantially in contact with the angular stop 15b of the auxiliary drive wheel 15.

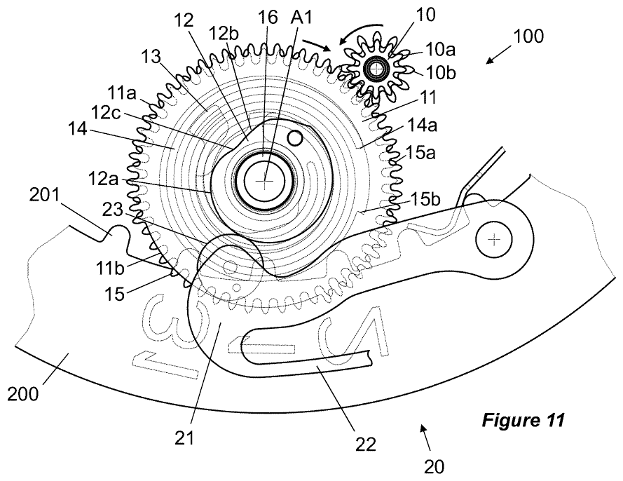

Therefore, given that the angular speed of the auxiliary wheel 15 is slightly higher than that of the main wheel 11, the angular stop 15b gradually gets further and further away from the free end 14a as the energy accumulation device is wound, as illustrated in FIG. 11.

At the end of the arming phase, the angular spacing between the free end 14a and the angular stop 15b corresponds or substantially corresponds to the angular extent of the portion 11b and thus to the angular travel covered by the cam 12 during the instantaneous driving phase.

During the driving phase, the main mobile, notably the main wheel 11, the cam 12 and the spring 14, instantaneously cover the angular travel required to drive the display member 200. As a reminder, said angular travel corresponds to the angular extent of the portion 11b and consequently to the maximum angular spacing between the free end 14a and the angular stop 15b. Said angular spacing is therefore instantaneously compensated during the driving phase. The free end 14a and the angular stop 15b are back in contact or substantially in contact after this phase.

In addition or as an alternative, the elastic device 14 may be shaped so as to make it possible to partially or completely dissipate the residual kinematic energy after the driving of the display member 200, which is to say at the end of the driving phase.

This second embodiment advantageously makes it possible to drive the display member 200 in the opposite direction of operation, without running the risk that the main wheel 11 is desynchronized from the train of the timepiece movement 400. To this end, by contrast to the first embodiment the portion 11b does not interact with the mobile 10 in the manner of a Maltese cross, but is out of the range of the latter. For example, the portion 11b is made up of a portion of a cylinder having a radius equal or substantially equal to the radius of the root circle of the toothing 11a.

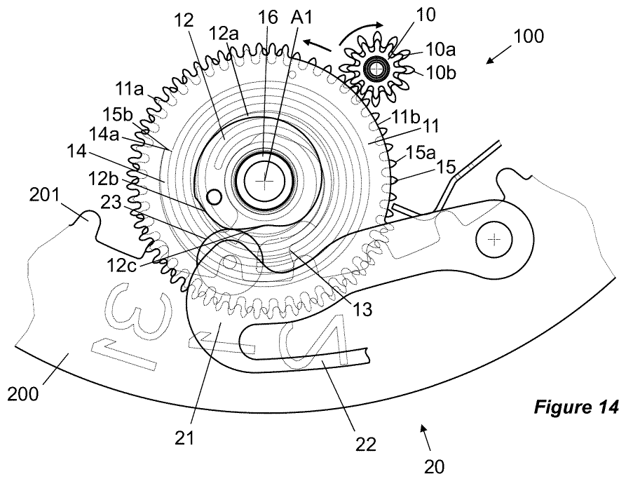

When the train of the timepiece movement is actuated in the opposite direction of operation, the auxiliary toothing 10b drives the toothing 15a of the auxiliary wheel in the opposite direction to the hands of a watch, and the toothing 10a drives the toothing 11a of the main wheel until the portion 11b faces the pinion 10, in other words until the lever 21, in particular the runner 23, is on the stop portion 12c. Therefore, the toothing 10a turns with no load and no longer makes it possible to drive the main wheel 11 in the opposite direction. As illustrated in FIG. 14, the main wheel 11 is then driven by the auxiliary wheel 15 via the spring 14 by virtue of its free end 14a in contact with the angular stop 15b. Of course, the elastic device 14 is dimensioned so as to have sufficient angular stiffness to overcome the torque generated by the interaction of the energy accumulation device 20 with the return portion 12b, and thus make it possible to drive the display member 200 in the opposite direction.

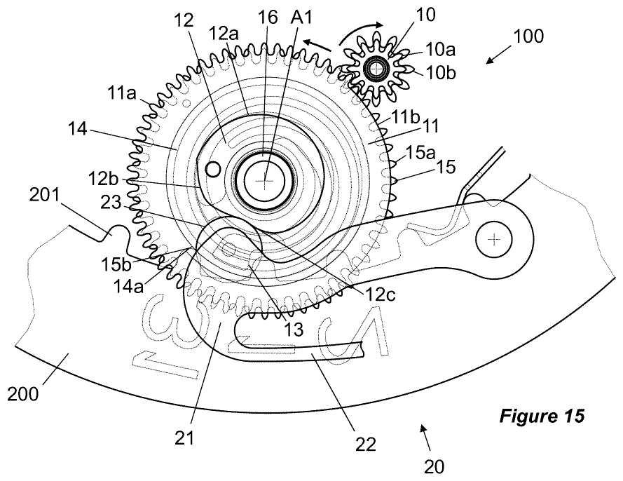

Once the return portion 12b has been completely travelled over in the opposite direction, at the exact moment it transitions to the arming portion 12a, the toothing 10a interacts with the toothing 11a of the main wheel 11 again. Therefore, the spring 14 starts to be armed as a consequence of the slight difference in angular speed between the main wheel 11 and the auxiliary wheel 15. The maximum arming level of the spring 14 is reached when the toothing 10a faces the portion 11b again, as illustrated in FIG. 15. The angular displacement or deformation of the free end 14a corresponding to its maximum arming is equal or substantially equal to the angular travel covered by the cam 12 during the instantaneous driving phase.

At that moment, the main wheel 11 is decoupled from the mobile 10 and the energy accumulated in the spring 14 is consequently returned so as to drive the main wheel 11 and the display member 200 instantaneously or substantially instantaneously in the opposite direction. The elastic device 14 is thus also dimensioned so as to accumulate enough energy for the lever 21, in particular the runner 23, to be able to go back up the return portion 12b in the opposite direction of operation.

Continuing to actuate the train of the timepiece movement 400 in the opposite direction makes it possible to initiate a new phase of arming the elastic device 14 by virtue of the interaction of the toothing 10a of the mobile 10 with the toothing 11a of the main wheel 11.

With the second embodiment, resetting the time in the opposite direction thus enables a first dragging drive of the display member 200 and then, in succession, instantaneous or substantially instantaneous drives in the opposite direction.

It should be noted that the energy required to arm the elastic device 14 is provided by the user when they reset the time in the opposite direction. In other words, this energy is not provided by the timepiece movement 400.

The invention also relates to a method for operating a timepiece drive device 100 as described above. As seen above, the operating method comprises arming the energy accumulator 22 via the cam follower 21 substantially permanently, except for driving phases in which the cam 12 is driven by the energy accumulator 22 via the cam follower 21.

Advantageously, the duration of the arming corresponds to at least 90% of the time of the period of rotation of the main wheel 11 of the timepiece drive device 100, or even at least 99%, or even at least 99.5%, or even substantially 100% of the time of the period of rotation of the main wheel 11 of the timepiece drive device 100.

With preference, the method comprises at least one iteration of the following steps, notably multiple iterations of the following steps:
bringing the first toothing 10a and the second toothing 11a into meshing engagement so as to drive the cam 12 for arming the energy accumulator 22, and then
bringing the first toothing 10a and the second toothing 11a out of meshing engagement and driving the cam 12 by the energy accumulator 22 via the cam follower 21.

The proposed solution advantageously makes it possible to even out the energy consumption of the timepiece movement 400 during the arming phase, which corresponds substantially to the period of rotation of the main wheel 11 except for the instantaneous driving phase and the potential lag caused by the meshing clearances on the transition between the instantaneous-jump phase and the arming phase. Consequently, the energy consumed and therefore the losses of amplitude of the balance can be constant or substantially constant, by contrast to the solutions known from the prior art.

In addition, given that the energy required to instantaneously drive the display member 200 can be accumulated over a longer duration or period of rotation than those of the known solutions, it is also possible to reduce the instantaneous consumption for the same total amount of accumulated energy. By increasing the arming duration from 13 hours to 24 hours, it is for example possible to reduce the arming power by 46%. By increasing the arming duration from 20 hours to 24 hours, it is for example possible to reduce the arming power by 17%.

Advantageously, the instantaneous drive device 100 also makes it possible to directly drive the display member 200, exclusively implementing a drive element 13. This is because the solution does not require a lever arranged at the interface between said members.

Of course, the solutions are not limited to a simple date calendar system but are also particularly suitable for calendar systems that require for example more energy, such as an annual date or a perpetual date calendar. More generally, the solutions can be applied to any instantaneous-jump display system for displaying time-based or time-derived information.

In the embodiments described, it is provided that the calendar system 300 is driven by at least one pitch for each period of rotation of the main drive wheel 11. However, irrespective of the embodiment or the variant, the instantaneous drive device could be adapted so as to drive the display system for each multiple or each sub-multiple of the period of rotation of the main drive wheel 11. Of course, the geometries of the cam 12 and of the main wheel 11 must be specified as a result.

Irrespective of the embodiment or the variant, the cam 12 could be replaced by a simple geometry, such as a pin, which interacts with a profile, similar to a cam profile, formed on the cam follower 21 of the energy accumulation device 20.

Irrespective of the embodiment or the variant, the toothings of the mobile 10 and of the main wheel 11 could be produced over multiple separate levels, notably first and second levels. This makes it possible to distribute the drive by appropriately truncating certain teeth of the first level and/or of the second level so as to optimize the successive operations of bringing these teeth into meshing engagement and taking them out of meshing engagement between the arming and driving phases. This configuration can be particularly advantageous if the mobile 10 comprises a lot of teeth and/or if the difference in pitch diameter between the mobile 10 and the main wheel 11 is too small. This configuration can also make it possible to optimize the toothing profiles so as to limit, or even eliminate to the greatest possible extent the meshing clearance on the transition between respectively the instantaneous-jump phase and the arming phase. In addition or as an alternative, this shaping on two or more levels of the teeth of the mobile 10 and of the main wheel 11 could also be particularly advantageous for, for example, implementing a function of the Maltese cross type on a first level and a meshing engagement on a second level.

Irrespective of the embodiment or the variant, with preference the drive device, in particular the profile of the cam 12, is arranged such that the mechanical power supplied to the energy accumulator 22 is constant or substantially constant throughout the period of time or substantially throughout the period of time during which the cam 12 is not driven by the energy accumulator 22 via the cam follower 21.

With preference, “instantaneous” means an action having a duration of about one or more fractions of a second, typically approximately one hundredth of a second or approximately one twenty-fifth of a second or else approximately one tenth of a second.

By contrast, “dragging” means an action, such as a displacement, which is slow and even and lasts for example for at least several seconds.

1. A timepiece drive device comprising:
an input mobile which includes a first toothing;
a main wheel which includes a second toothing only over part of the periphery of the main wheel, the second toothing being in meshing engagement with the first toothing,
a cam which is connected to the main wheel and has a cam profile,
a cam follower which interacts with the profile, and
an energy accumulator which elastically returns the cam follower against the profile of the cam.

2. The timepiece drive device as claimed in claim 1, wherein
an angular extent of a periphery of the main wheel which comprises the second toothing is equal or substantially equal to an angular travel covered by the cam when the cam is not driven by the energy accumulator via the cam follower, and/or
an angular extent of the periphery of the main wheel without toothing is equal or substantially equal to an angular travel covered by the cam when the cam is driven by the energy accumulator via the cam follower, and/or
the timepiece drive device is arranged so that an action of the cam follower on the cam causes the main wheel rotate independently of the input mobile.

3. The timepiece drive device as claimed in claim 1, wherein the timepiece drive device is arranged so as to arm the energy accumulator via the cam follower substantially permanently, except for driving phases in which the cam is driven by the energy accumulator via the cam follower.

4. The timepiece drive device as claimed in claim 1, wherein the drive device is arranged so that:
the cam is driving by an action of the energy accumulator via the cam follower over a first angular extent, and
the cam supplies energy to the energy accumulator via the cam follower over a second angular extent which complements the first angular extent.

5. The timepiece drive device as claimed in claim 1, wherein the timepiece drive device is arranged so that a mechanical power supplied to the energy accumulator is constant or substantially constant throughout a period of time or substantially throughout a period of time during which the cam is not driven by the energy accumulator via the cam follower.

6. The timepiece drive device as claimed in claim 1, wherein the cam follower comprises a lever.

7. The timepiece drive device as claimed in claim 1, wherein the energy accumulator comprises a spring.

8. The timepiece drive device as claimed in claim 1, wherein the cam is kinematically connected to a drive element for driving a display element for displaying time-based information.

9. A timepiece calendar comprising:
the timepiece drive device as claimed in claim 1, and
a display element for displaying time-based information, the display element including a toothing.

10. A timepiece movement
comprising the timepiece drive device as claimed in claim 1.

11. A timepiece
comprising the timepiece movement as claimed in claim 10.

12. A method for operating a timepiece drive device, the timepiece drive device comprising:
a cam,
a cam follower, and
an energy accumulator which returns the cam follower against the cam, the method comprising arming the energy accumulator via the cam follower substantially permanently, except for driving phases in which the cam is driven by the energy accumulator via the cam follower.

13. The method as claimed in claim 12, wherein a duration of the arming corresponds to at least 90% of a time of a period of rotation of the main wheel of the timepiece drive device.

14. The method as claimed in claim 12, comprising at least one iteration of the following:
bringing a first toothing and a second toothing into meshing engagement so as to drive the cam for arming the energy accumulator, and then
bringing the first toothing and the second toothing out of meshing engagement and driving the cam by the energy accumulator via the cam follower.

15. The method as claimed in claim 12, wherein the drive of the cam is an instantaneous drive.

16. The timepiece drive device as claimed in claim 1, which is a device for displaying time-based or time-derived information.

17. The timepiece drive device as claimed in claim 16, which is adapted for an instantaneous-jump calendar system.

18. The timepiece drive device as claimed in claim 2, wherein the cam, the first toothing and the second toothing are arranged so that the action of the cam follower on the cam causes the main wheel to rotate independently of the input mobile.

19. The timepiece drive device as claimed in claim 3, wherein the cam, the first toothing and the second toothing are arranged so as to arm the energy accumulator via the cam follower substantially permanently, except for the driving phases in which the cam is driven by the energy accumulator via the cam follower.

20. The timepiece drive device as claimed in claim 1, wherein the profile of the cam is arranged so that a mechanical power supplied to the energy accumulator is constant or substantially constant throughout a period of time or substantially throughout a period of time during which the cam is not driven by the energy accumulator via the cam follower.
